(19) United States
(12) Patent Application Publication
(10) Pub. No.: US 2009/0107636 A1
(43) Pub. Date: Apr. 30, 2009

(54) TWO-SIDE ADHESIVE TAPE DEVICE

(76) Inventor: CHUN-JUNE YANG, Taipei City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/924,764

(22) Filed: Oct. 26, 2007

(51) Int. Cl. B29C 65/00

(52) U.S. Cl. 156/458

(57) ABSTRACT

A two-side adhesive tape device comprises a two-side adhesive tape, a tape feeding member disposed therein for rotating and receiving the adhesive tape thereon, a tape collecting member mounted therein and actuated to rotate by an actuation disc so as to affix the adhesive tape and collect a base layer of the adhesive tape after use, a rolling head arranged therein for rotatably actuating the adhesive tape to contact with an unstuck object and for urging the actuation disc to rotate simultaneously, the actuation disc provided therein for connecting with the tape collecting member and the rolling head, such that the tape collecting member and the rolling head may be actuated by each other through the actuation disc, a housing including a receiving compartment formed therein and having a plurality of predetermined positions defined therein for fixing the tape feeding member, the tape collecting member, the rolling head, and the actuation disc respectively.

### BACKGROUND OF THE INVENTION

1. Field of the Invention

The present invention relates to an adhesive tape device, and more particularly to a two-side adhesive tape device that may save the two-side adhesive tape while in use so as to achieve an environmentally friendly purpose.

2. Description of the Prior Arts

A two-side adhesive tape includes an adhesive tape and a release paper strap formed on two sides thereof and is rolled in the form of a cylinder, wherein the assortment of the adhesive tape is distinguished into base material and non-base material. The base material is made of cotton or cloth and includes adhesive applied onto two sides thereof, yet the non-base material includes a two-side release paper strap having adhesive applied thereon. While in use, the adhesive tape is cut to a desired length and then pressingly adhered to a predetermined position. Thereafter, the release paper strap opposite to the two-side adhesive tape is torn off, exposing the adhesive portion of the adhesive tape outwardly so as to stick an object.

However, such a prior art two-side adhesive tape has some defects. For example, an overlong or too short adhesive tape is cut, wasting the adhesive tape. Furthermore, the cut release paper straps fall everywhere after being peeled off, causing a mess.

The present invention has arisen to mitigate and/or obviate the afore-described disadvantages.

### SUMMARY OF THE INVENTION

The primary object of the present invention is to provide a two-side adhesive tape device that may save two-side adhesive tape while in use so as to achieve an environmentally friendly purpose.

In accordance with one aspect of the present invention, there is provided a two-side adhesive tape device comprising:

a two-side adhesive tape including a base layer formed in the shape of a thin film and including two surfaces disposed on the top and bottom thereof respectively, and including an adhesive layer comprised of a plurality of spot gels and bonding with one of the surfaces together;

a tape feeding member disposed at a predetermined position of the adhesive tape device so as to rotate and receive the adhesive tape thereon;

a tape collecting member mounted at another predetermined position of the adhesive tape device and actuated to rotate by an actuation disc so as to affix the adhesive tape and collect the base layer of the adhesive tape after use;

a rolling head arranged at another predetermined position of the adhesive tape device for rotatably actuating the adhesive tape to contact with an unstuck object, and for urging the actuation disc to rotate simultaneously;

the actuation disc provided at another predetermined position of the adhesive tape device for connecting with the tape collecting member and the rolling head, such that the tape collecting member and the rolling head may be actuated by each other through the actuation disc;

a housing including a receiving compartment formed therein and having a plurality of predetermined positions defined therein for fixing the tape feeding member, the tape collecting member, the rolling head, and the actuation disc respectively.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective diagram illustrating the assembly of a two-side adhesive tape according to the present invention;

FIG. 2 is a perspective diagram illustrating the exploded components of the two-side adhesive tape according to the present invention;

FIG. 3 is a perspective diagram illustrating the assembly of a two-side adhesive tape device according to the present invention;

FIG. 4 is a perspective diagram illustrating a tape feeding member, a tape collecting member, a rolling head, and an actuation disc being disposed in a housing according to the present invention;

FIG. 5 is a perspective diagram illustrating the exploded components of the two-side adhesive tape device according to the present invention;

FIG. 6 is another perspective diagram illustrating the exploded components of the two-side adhesive tape device according to the present invention;

FIG. 7 is a partial perspective diagram illustrating the operation of the two-side adhesive tape device according to the present invention;

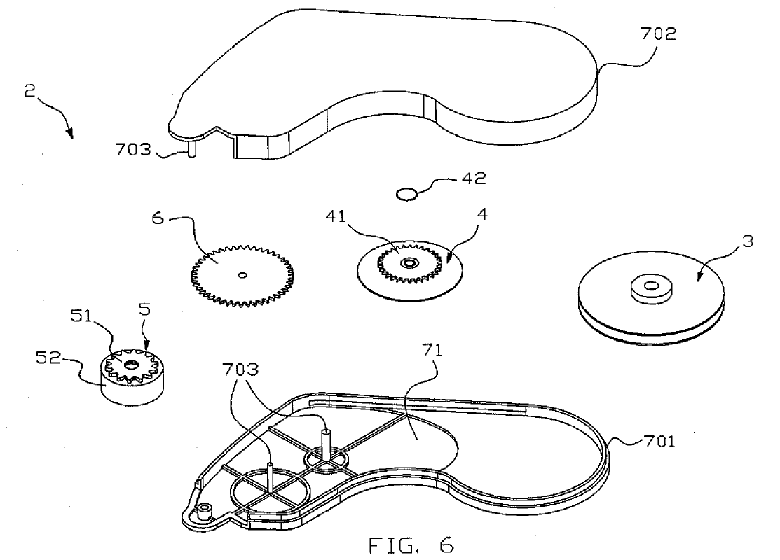

FIG. 6 is another partial perspective diagram illustrating the operation of the two-side adhesive tape device according to the present invention.

### DETAILED DESCRIPTION OF THE PREFERRED EMBODIMENT

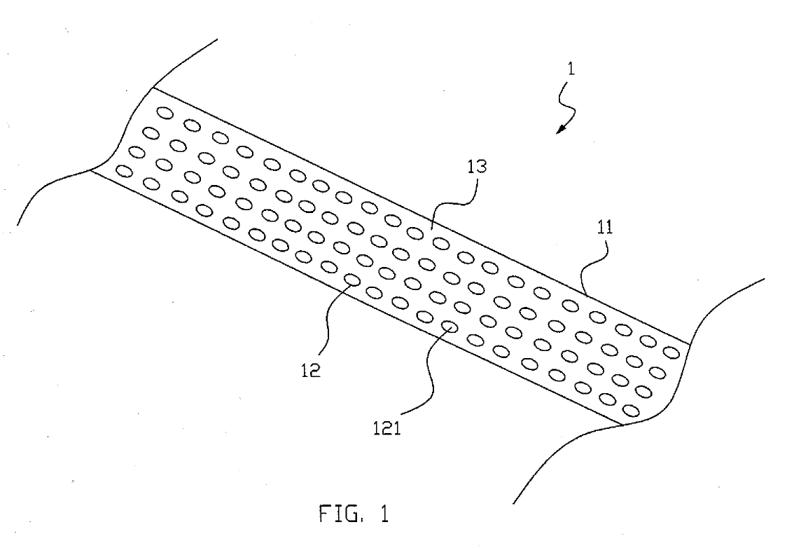

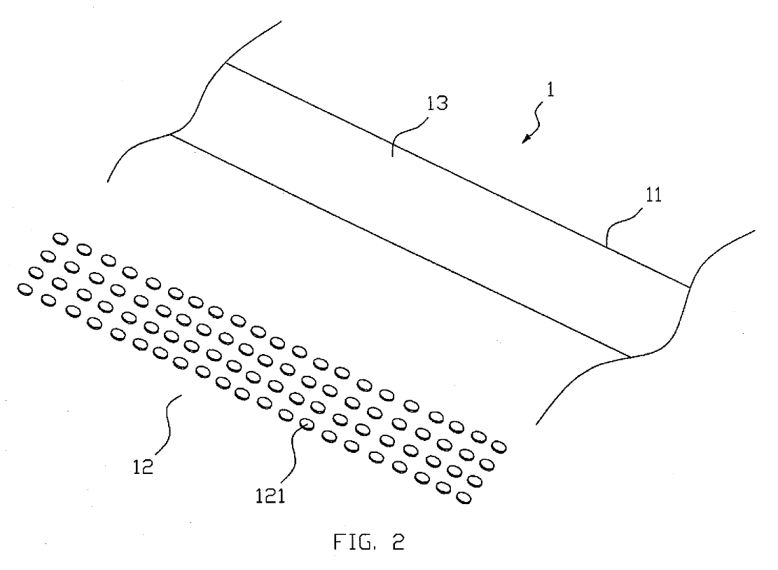

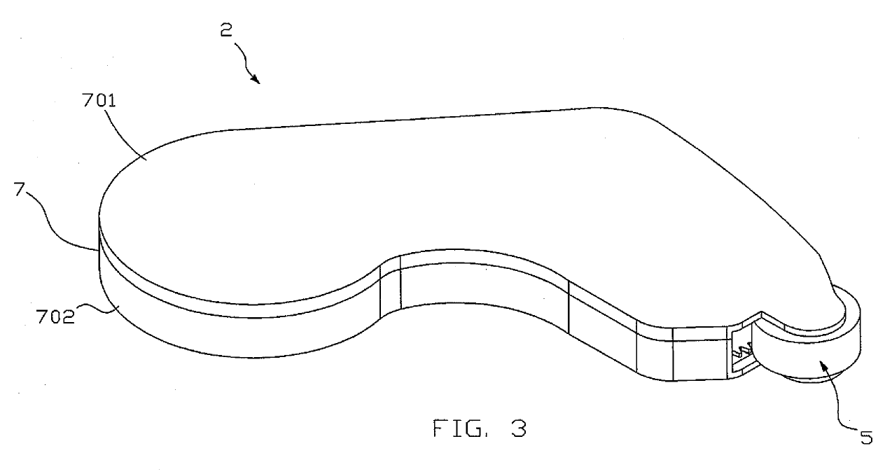

Referring to FIGS. 1-4, a two-side adhesive tape device in accordance with the present invention comprises a two-side adhesive tape 1 including a base layer 11 and an adhesive layer 12, wherein the base layer 11 is formed in the shape of a thin film and includes two surfaces 13 disposed on the top and bottom thereof respectively; while the adhesive layer 12 is comprised of a plurality of spot gels 121, and bonds with one of the surfaces 13 together, thereby forming the adhesive tape 1. Besides, each of the surfaces 13 of the base layer 11 is a smooth plane so that the adhesive layer 12 may be separated from the base layer 11 easily, and then attached to an unstuck object brilliantly. Each of the spot gels 121 is a sticky colloid in the form of a spot and attached onto one of the surfaces 13 of the base layer 11 in order, forming the adhesive layer 12.

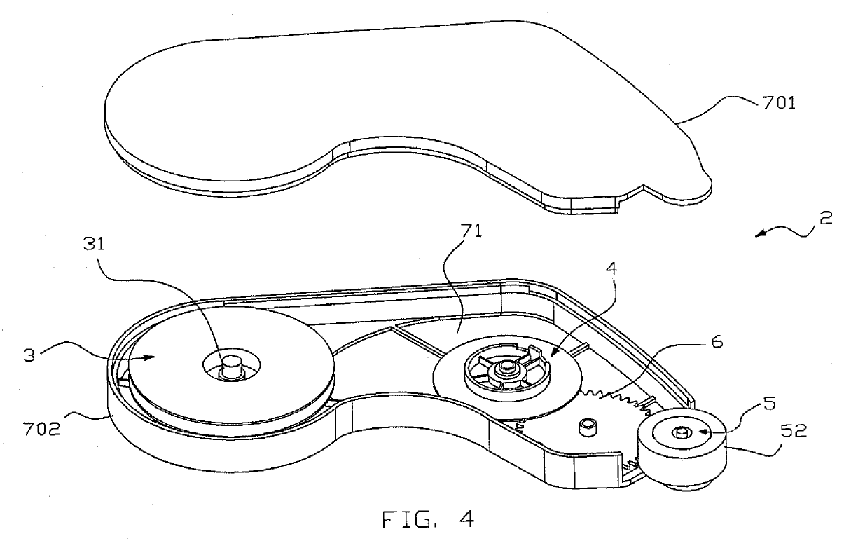

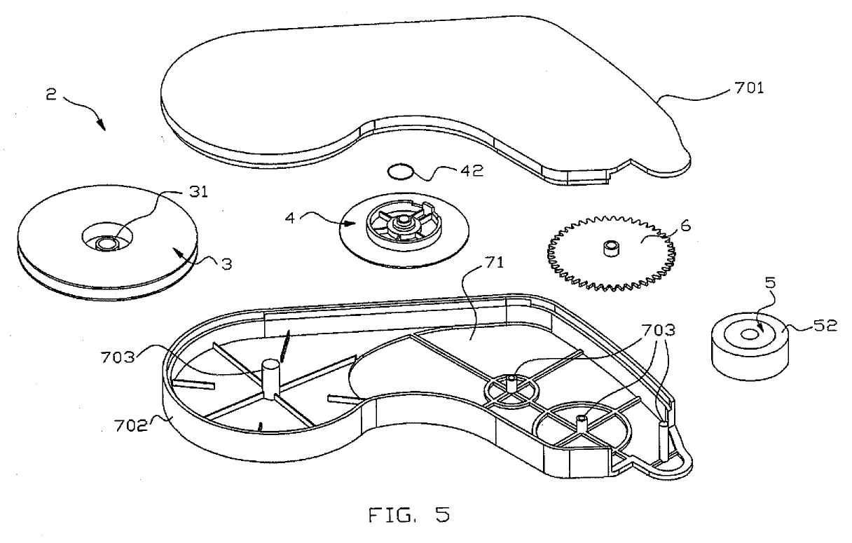

As shown in FIGS. 3-4, a two-side adhesive tape device in accordance with the present invention comprises:

a tape feeding member 3 disposed at a predetermined position thereof so as to rotate and receive the adhesive tape 1 thereon;

a tape collecting member 4 mounted at another predetermined position of the adhesive tape device 2 and actuated to rotate by an actuation disc 6 so as to affix the adhesive tape 1 and collect the base layer 11 of the adhesive tape 1 after use;

a rolling head 5 arranged at another predetermined position of the adhesive tape device 2 for rotatably actuating the adhesive tape 1 to contact with the unstuck object, and for urging the actuation disc 6 to rotate simultaneously;

the actuation disc 6 provided at another predetermined position of the adhesive tape device 2 for connecting with the tape collecting member 4 and the rolling head 5, such that the tape collecting member 4 and the rolling head 5 may be actuated by each other through the actuation disc 6;

a housing 7 including a receiving compartment 71 formed therein and having a plurality of predetermined positions defined therein for fixing the tape feeding member 3, the tape collecting member 4, the rolling head 5, and the actuation disc 6 respectively.

Referring to FIGS. 5-6, in assembly, the tape feeding member 3 is fitted to an upright pillar 703 secured at a predetermined position of the housing 7 by using a stop member 31 thereof, thereby the adhesive tape 1 is rolled and received on the tape feeding member 3, wherein the stop member 31 is located between the tape feeding member 3 and the upright pillar 703 for providing the friction force to the tape feeding member 3, and for assuring the force exerted onto the tape feeding member 3 is greater than the friction force resulting from the stop member 31 so that the tape feeding member 3 may be pulled without rotating randomly. The tape collecting member 4 is fitted to another upright pillar 703 at another predetermined position of the housing 7, and includes teeth 41 arranged thereon with which the actuation disc 6 is engaged, such that as the actuation disc 6 rotates the tape collecting member 4 is actuated to rotate simultaneously, therefore the used base layer 11 may be collected on the tape collecting member 4. The tape collecting member 4 also includes a rubber pad 42 formed thereon with which the upright pillar 703 contacts, so that the base layer 11 rubs with the upright pillar 703 as the rotation of the tape collecting member 4, thereby stably collecting the used base layer 11 on the tape collecting member 4. The rolling head 5 is fitted to another upright pillar 703 at another predetermined position of the housing 7, and includes peripheral teeth 51 arranged thereon for engaging with the actuation disc 6, such that as the rolling head 5 rotates the adhesive tape 1 is actuated to contact with the unstuck object, and by means of the peripheral teeth 51, the actuation disc 6 is urged to rotate. On the other hand, the rolling head 5 includes a rubber surface 52 formed therearound and while contacting with one of the surfaces 13 of the base layer 11, a friction force may be generated to pull the adhesive tape 1. The actuation disc 6 is fitted to another pillar 703 at another predetermined position of the housing 7 for the engagement with the tape collecting member 4 and the rolling head 5, such that the tape collecting member 4 and the rolling head 5 may be actuated to rotate by each other. The housing 7 is comprised of an upper housing 701 and a lower housing 702, and includes a receiving compartment 71 formed therein and having a plurality of predetermined positions defined therein for receiving the tape feeding member 3, the tape collecting member 4, the rolling head 5, and the actuation disc 6 individually, and they may be securely affixed by the upright pillars 703 of the housing 7. The adhesive tape 1 is rolled on the tape feeding member 3, and one end thereof is extended out of the tape feeding member 3, passed through and abutted against the rolling head 5, then further pulled to mount on the tape collecting member 4, thus installing the adhesive tape 1 in the adhesive tape device 2.

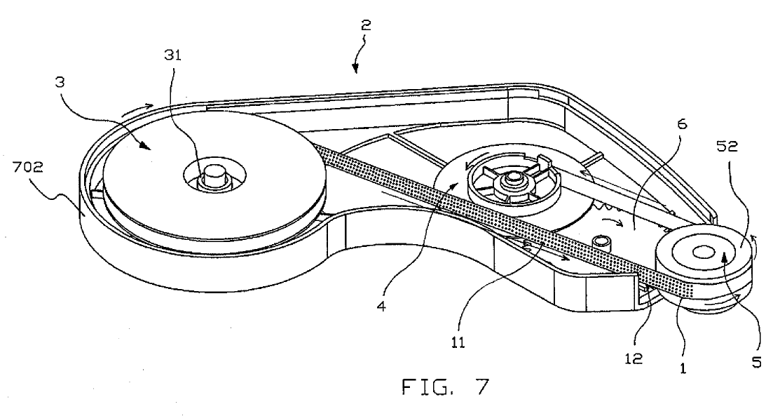

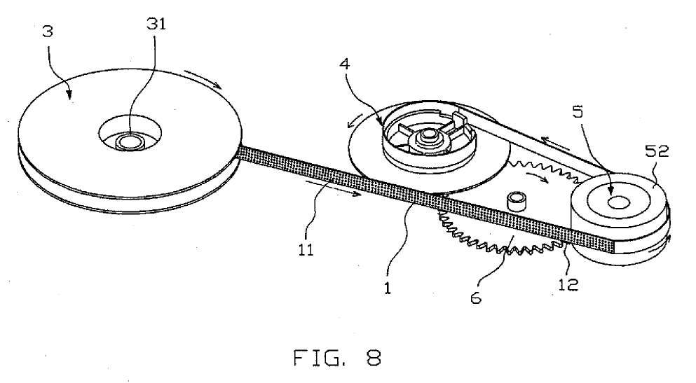

As illustrated in FIG. 7, in operation, the rolling head 5 is aligned to the predetermined attaching position of the unstuck object, in the meantime, the adhesive tape 1 passed through and abutted against the rolling head 5 is located between the rolling head 5 and the unstuck object, since one side of the adhesive tape 1 having the adhesive layer 12 faces the unstuck object, by slightly exerting force onto the adhesive tape device 2, the rolling head 5 engageably abuts against the unstuck object, and then the adhesive tape device 2 is moved along the predetermined sticking area, meanwhile, the rolling head 5 actuates the adhesive tape 1 between the rolling head 5 and the unstuck object, so that the adhesive layer 12 on the adhesive tape 1 separates from the base layer 11 and then attaches onto the surface of the unstuck object. During the rotation of the rolling head 5, the actuation disc 6 is actuated simultaneously for urging the tape collecting tape 4 by which the adhesive tape 1 is actuated, and the base layer 1 is collected on the tape collecting member 4 after use.

The invention is not limited to the above embodiment but various modifications thereof may be made. It will be understood by those skilled in the art that various changes in form and detail may made without departing from the scope and spirit of the present invention.

What is claimed is:

1. A two-side adhesive tape device comprising:
a two-side adhesive tape including a base layer formed in the shape of a thin film and including two surfaces disposed on the top and bottom thereof respectively, and including an adhesive layer comprised of a plurality of spot gels and bonding with one of said surfaces together;
a tape feeding member disposed at a predetermined position of said adhesive tape device so as to rotate and receive said adhesive tape thereon;
a tape collecting member mounted at another predetermined position of said adhesive tape device and actuated to rotate by an actuation disc so as to affix said adhesive tape and collect said base layer of said adhesive tape after use;
a rolling head arranged at another predetermined position of said adhesive tape device for rotatably actuating said adhesive tape to contact with an unstuck object, and for urging said actuation disc to rotate simultaneously;
said actuation disc provided at another predetermined position of said adhesive tape device for connecting with said tape collecting member and said rolling head, such that said tape collecting member and said rolling head may be actuated by each other through said actuation disc;
a housing including a receiving compartment formed therein and having a plurality of predetermined positions defined therein for fixing said tape feeding member, said tape collecting member, said rolling head, and said actuation disc respectively.

2. The two-side adhesive tape device as claimed in claim 1, wherein each of said surfaces of said base layer is a smooth plane.

3. The two-side adhesive tape device as claimed in claim 1, wherein said tape feeding member is provided to roll and receive said adhesive tape thereon.

4. The two-side adhesive tape device as claimed in claim 1, wherein said tape feeding member connects with said housing by way of a stop member.

5. The two-side adhesive tape device as claimed in claim 1, wherein said housing is comprised of an upper housing and a lower housing for securely affixing said tape feeding member, said tape collecting member, said rolling head, and said actuation disc at predetermined positions thereof by means of upright pillars.

6. The two-side adhesive tape device as claimed in claim 1, wherein said tape collecting member includes teeth arranged thereon with which said actuation disc is engaged, such that as said actuation disc rotates said tape collecting member is actuated to rotate simultaneously.

7. The two-side adhesive tape device as claimed in claim 1, wherein said tape collecting member also includes a rubber pad formed thereon with which said upright pillar contacts, for providing a friction force to generate the stable rotation thereof.

8. The two-side adhesive tape device as claimed in claim 1, wherein said rolling head includes peripheral teeth arranged thereon for engaging with said actuation disc, such that as said rolling head rotates said actuation disc is accordingly urged to rotate.

9. The two-side adhesive tape device as claimed in claim 1, wherein said rolling head includes a rubber surface formed therearound and while contacting with one of said surfaces of said base layer, a friction force may be generated to pull said adhesive tape.
